(19) United States
(12) Patent Application Publication
(10) Pub. No.: US 2007/0251555 A1
(43) Pub. Date: Nov. 1, 2007

(54) Dishwasher

(75) Inventors: Soung Bong Choi, Gyeongsangnam-do (KR); Sangheon Yoon, Gyeonggi-do (KR); Nungseo Park, Seoul (KR); Dae Yeong Han, Seoul (KR); Hung Myong Cho, Gyeongsansnam-do (KR); Byung Hwan Ahn, Gyeongsangnam-do (KR); Chaseung Jun, Seoul (KR); Byoungwook Min, Seoul (KR)

Correspondence Address: MCKENNA LONG & ALDRIDGE LLP, 1900 K STREET, NW, WASHINGTON, DC, 20006, US

(73) Assignee: LG ELECTRONICS, INC., Youngdungpo-gu (KR)

(21) Appl. No.: 10/558,437

(22) PCT Filed: Sep. 15, 2005
(86) PCT No.: PCT/KR05/03053

§ 371 Date: Jun. 15, 2007

(30) Foreign Application Priority Data
Sep. 16, 2004 (KR) P 2004-74093
Oct. 21, 2004 (KR) P 2004-84416

(51) Int. Cl. B08B 3/10; A47L 15/42

(52) U.S. Cl. 134/105; 134/140

(57) ABSTRACT

The present invention relates to dishwashers, and more particularly, to a dishwasher which enables effective use of a tub space dishes are placed thereon, and easy mounting of a motor to a sump. The dishwasher in one aspect of the present invention includes a tub for placing dishes to be washed therein, a sump for holding washing water to wash the dishes in the tub, and a motor having a rotor and a stator for generating pumping force to pump the washing water from the sump to the tub, wherein the stator of the motor has a concentrated winding. The dishwasher in another aspect of the present invention includes a tub for placing dishes to be washed therein, a sump for holding washing water to wash the dishes in the tub, the sump having a shaft hole, and guide pieces projected outward, and a motor for generating pumping force to pump the washing water from the sump to the tub, the motor having guide holes for receiving the guide pieces on the sump.

### TECHNICAL FIELD

The present invention relates to dishwashers, and more particularly, to a dishwasher which enables effective use of a tub space dishes are placed thereon, and easy mounting of a motor to a sump.

### BACKGROUND ART

A related art dishwasher will be described with reference to FIG. 1.

The dishwasher 1 is an appliance for spraying washing water to dishes for washing the dishes. The dishwasher 1 is provided with a tub 3 for placing the dishes therein to wash the dishes, a portion 5 (hereafter called as a driving unit mounting portion) under the tub 3 having various electric components and the like mounted therein for supplying the washing water to the tub 3 at a high pressure.

The tub 3 and the driving unit mounting portion 5 will be described.

The tub 3 has a door 7 mounted on a front for opening/closing the tub 3. In the tub 3, there are an upper rack 12 and a lower rack 14 for placing the dishes thereon, and under the upper rack 12 and the lower rack 14, there are an upper spray arm 32 and a lower spray arm 34 for spraying the washing water, respectively. At a lower portion of the tub 3, there is a heater 13 for heating the washing water to a predetermined temperature.

In the meantime, in the driving unit mounting portion 5, there is a sump 9 for holding the washing water, and at the sump 9, there is a washing pump for pumping the washing water to the upper spray arm 32 and the lower spray arm 34 in the tub 3. In general, the sump 9, the upper spray arm 32, and the lower spray arm 34 are connected with an upper connection pipe 322 and a lower connection pipe 324.

In general, the washing pump is provided with a motor 100 for generating driving power, and an impeller (not shown) connected to the motor 100.

The operation of the related art dishwasher will be described.

Upon putting the dishwasher 1 into operation, the washing water is pumped by the washing pump to the upper spray arm 32 and/or the lower spray arm 34 in the tub 3. According to this, the washing water is sprayed from the upper spray arm 32 and the lower spray arm 34 to the dishes on the upper rack 12 and the lower rack 14, to wash the dishes. The washing water may be supplied to either the upper spray arm 32 or the lower spray arm 34 singly, or both to the upper spray arm 32 and the lower spray arm 34 at the same time.

The washing water sprayed to the dishes is recovered to the sump 9 through recovery holes (not shown) in communication with the sump 9, again. The washing water having soil contained therein as a result of washing the dishes may be filtered by filtering means.

However, the related art dishwasher has a problem in that the large sized driving unit mounting portion impedes effective utilization of a height or a space of the tub 3, which reason will be described in detail.

First, in the related art, a general induction motor is used as the washing pump motor as it is. However, the general induction motor has a great height in general, to lead a height or a size of the driving unit mounting portion 5 great, to impair utilization of the tub 3 space.

Second, in the related art, the heater 13 is in the lower portion of the tub 3. That is, the heater 13 is mounted between the lower spray arm 34 and a bottom of the tub 3. Therefore, it is required to secure a space for mounting the heater 13 between the lower spray arm 34 and the bottom of the tub 3, which is an unnecessary space in view of the tub 3.

In the meantime, FIG. 2 illustrates an exploded perspective view of a sump 20 and a motor 40 in a case the motor 40 is mounted to an underside of the sump 20 in a dishwasher.

The sump 20 is provided with a recess 22 recessed down at a center for holding the washing water.

The motor 40 is fastened to the sump 20 under the recess 22 by using screw fastening holes 46 and screw fastening bosses 26 for providing power to circulate the washing water.

At the sump 20, there are a flow passage change-over motor 62 for controlling a direction of flow passage of the washing water and a drain motor 64 for draining the washing water, provided thereto.

FIG. 3 illustrates a bottom perspective view of the sump.

For mounting the motor 40, at a center of the recess 22, there is a shaft mounting hole 24 for pass through of the rotation shaft of the motor 40.

Moreover, there are a plurality of the screw fastening bosses 26 projected downward from the underside of the recess 22 for fastening the motor 40 with screws.

Referring to FIG. 2, the motor 40 has the screw fastening holes 46 at portions opposite to the screw fastening bosses 26, so that the rotation shaft 44 of the motor 40 is passed through the shaft mounting hole 24 in the sump 20, coupled to other components, such as a disposer (not shown) and an impeller (not shown), and fastened with screws as fastening screws (not shown) are fastened to the screw fastening holes 46 in the motor 40 and the screw fastening bosses 26 on the sump 20, to secure the motor 40 to the sump 20.

Moreover, on an upper surface of the shaft mounting hole 20 in the sump 20, there is a sealing member 50 rotatably mounted to the rotation shaft 44 for sealing between the rotation shaft 44 of the motor 40 and the shaft mounting hole 24.

Moreover, the flow passage change-over motor 62 for controlling a direction of a flow passage of the washing water and the drain motor 64 for draining the washing water are provided to the sump 20.

However, the related art dishwasher has the following problems in a motor mounting structure.

First, though a worker is required to fasten screws after aligning positions of the screw fastening holes and the screw fastening bosses in mounting the motor to the sump, the fastening is not convenient because the motor is relatively heavy and the fastening is required to be carried out keeping the positions of the screw fastening holes and the screw fastening bosses are aligned.

Second, the relatively heavy motor mounted to the sump causes sagging of a bottom of the sump, or distorts the bottom of the sump due to moment generated by rotation force when the motor is in operation.

### DISCLOSURE

### Technical Problem

An object of the present invention is to provide a dishwasher, in which a tub space is expanded for effective utilization of the space, and which enables effective utilization of a space of a driving unit mounting space.

Another object of the present invention is to provide a dishwasher which can provide a motor mounting structure which can improve workability, and has an improved strength of a bottom of a sump of a dishwasher.

### TECHNICAL SOLUTION

The object of the present invention can be achieved by providing a dishwasher including a tub for placing dishes to be washed therein, a sump for holding washing water to wash the dishes in the tub, and a motor having a rotor and a stator for generating pumping force to pump the washing water from the sump to the tub, wherein the stator of the motor has a concentrated winding.

Preferably, the motor has a diameter greater than a height of the motor, to have a required output. Preferably, the motor is of an outer rotor type. Preferably, the motor is a variable speed motor.

In the meantime, preferably, the motor is a DC motor, and more preferably, a brushless DC motor.

The sump has a heater mounted therein for heating the washing water in the sump.

The tub has an upper spray arm and a lower spray arm mounted therein wherein the washing water is not supplied to the upper spray arm and the lower spray arm at the same time. It is preferable that a rotation speed of the motor is increased when the washing water is supplied to the upper spray arm only.

In another aspect of the present invention, a dishwasher includes a tub for placing dishes to be washed therein, a sump for holding washing water to wash the dishes in the tub, and a motor having a rotor and a stator for generating pumping force to pump the washing water from the sump to the tub, wherein the stator of the motor has a diameter greater than a height of the motor, to have a required output.

In another aspect of the present invention, a dishwasher includes a tub for placing dishes to be washed therein, a sump for holding washing water to wash the dishes in the tub, and a motor having a rotor and a stator for generating pumping force to pump the washing water from the sump to the tub, wherein the motor is of an outer rotor type for making a length of the winding shorter.

In another aspect of the present invention, a dishwasher includes a sump for holding washing water to wash the dishes in the tub, the sump having a shaft hole, and guide pieces projected outward, and a motor having guide holes for receiving the guide pieces on the sump.

Preferably, the sump has a surface in contact with the motor, the surface having strength reinforcing ribs formed thereon.

Preferably, the dishwasher further includes a sealing member around the shaft hole in the sump, and a sealing member seating step around the shaft hole for seating the sealing member.

### ADVANTAGEOUS EFFECTS

The dishwasher of the present invention having the following excellent advantages has industrial applicability.

First, the reduction of a motor height enabling to reduce a height of a driving unit mounting portion permits to make a higher tub to use the tub more effectively. The mounting of the heater in the driving unit mounting portion, i.e., in the sump permits effective use of the tub space.

Second, the reduction of the motor also permits effective use of a space of the driving unit mounting space.

Third, the alignment of the screw fastening bosses with the screw fasting holes, and the preliminary assembly of the sump and motor at the time of mounting the motor to a bottom of the sump by means of the guide pieces on the sump bottom and the guide holes in the upper surface of the motor permits to improve assemble workability.

Fourth, the strength reinforcing ribs on the bottom of the sump on which the motor is to be mounted prevent the sump from being deformed by a weight and rotation of the motor.

Fifth, the downward sealing seating step around the shaft hole in the sump for seating a sealing member improves assemble work of the sealing member, and permits to secure a more space as much as the downward step.

### DESCRIPTION OF DRAWINGS

FIG. 1 illustrates a longitudinal section of a related art dishwasher, schematically;

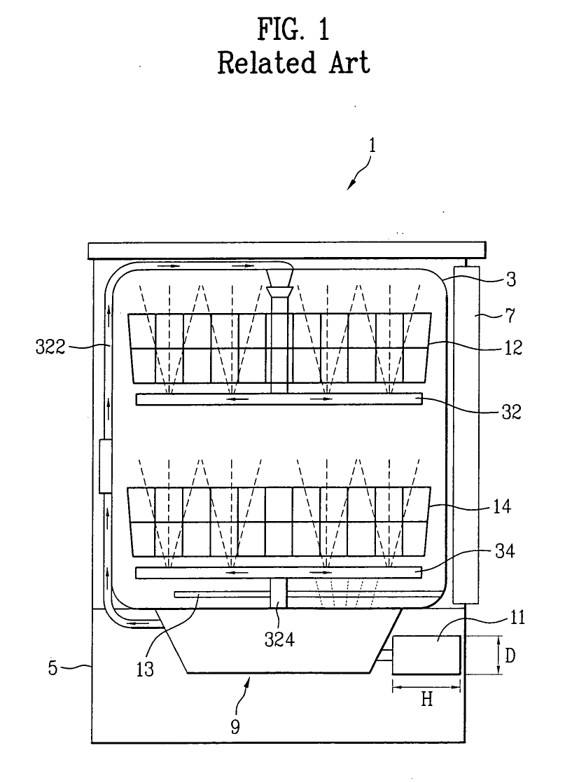

FIG. 2 illustrates an enlarged exploded perspective view a sump portion of a related art dishwasher;

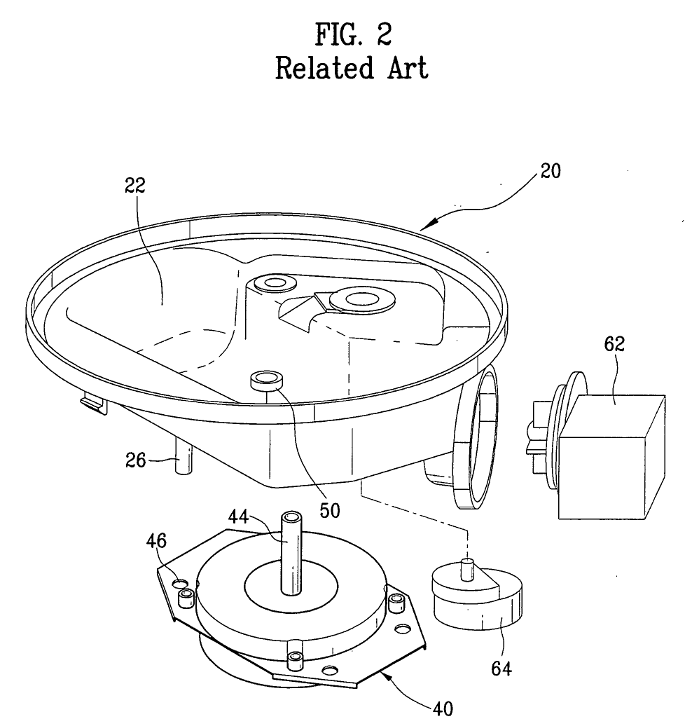

FIG. 3 illustrates a bottom perspective view of a sump in a related art dishwasher;

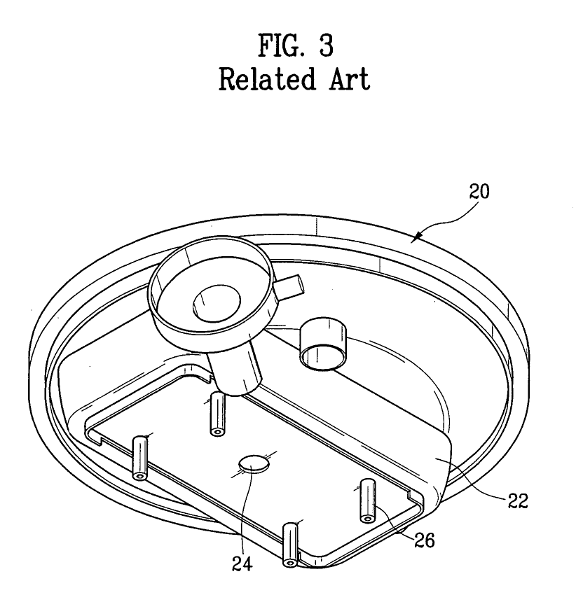

FIG. 4 illustrates a longitudinal section of a dishwasher in accordance with a preferred embodiment of the present invention, schematically;

FIG. 5 illustrates a section a mounting portion of a sump and a washing motor having a washing motor mounting structure of a dishwasher of the present invention applied thereto;

FIG. 6 illustrates a bottom perspective view of the sump in FIG. 5; and

FIG. 7 illustrates a perspective view of the washing motor in FIG. 5 seen from above.

### BEST MODE

A preferred embodiment of the present invention will be described with reference to the attached drawings.

Detailed description of parts of the dishwasher, not relevant to the nature of the present invention and the same with the related art, will be omitted.

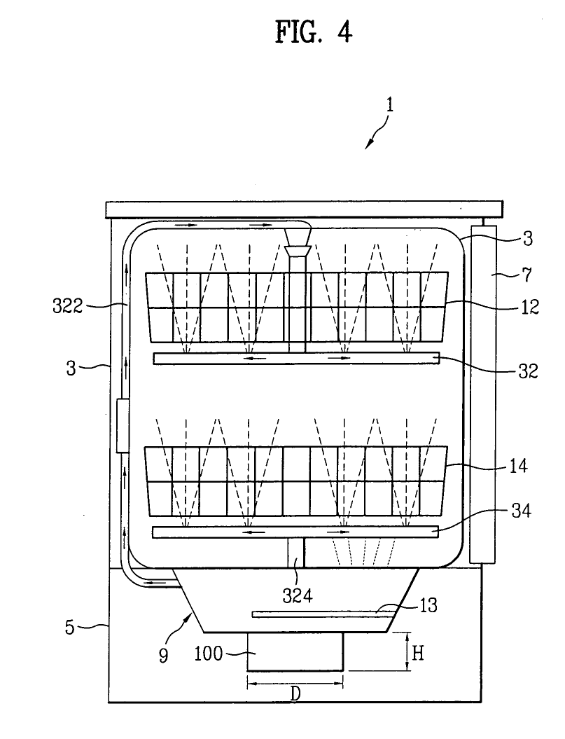

Referring to FIG. 4, the dishwasher 1 in accordance with a preferred embodiment of the present invention includes a tub 3 and a driving unit mounting portion 5, wherein the driving unit mounting portion 5 has a sump 9 and a washing pump motor 100 mounted thereto. However, different from the related art, the present invention has a heater 13 mounted to the sump 9. Moreover, the washing pump motor 100 is different from the related art, which will be described in detail.

For effective utilization of a space, specifically a height of the tub 3, the inventor finds out a scheme for reducing a height of the washing pump motor 100. That is, there have been no attempts to shorten a height of the motor 100 for effective utilization of the space of the tub 3. However, the inventor notices that the height of the driving unit mounting portion 5 can be reduced if a motor 100 having a smaller height while having the same performance is used, and it is possible that a space as much as the reduce height can be utilized as a space of the tub 3.

A method for reducing the height of the motor 100 while keeping the same performance will be described in detail.

At first, the inventor changes a winding type of the motor 100 to reduce the height of the motor 100. That is, the related art dishwasher uses a general induction motor 100 as it is, which has a great height due to use of distributed winding in general. Therefore, instead of the distributed winding, a concentrated winding is used, to reduce the height of the motor 100. That is, if the concentrated winding is used instead of the distributed winding, the height can be reduced even if power is the same.

In the meantime, even if even if the distributed winding is used as it is, the height ‘H’ of the motor 100 can be reduced if the diameter ‘D’ is increased while the height ‘H’ is reduced. That is, if the height ‘H’ can be reduced even if the diameter ‘D’ of the motor 100 is increased, the driving unit mounting portion 5 can be used effectively, because the driving unit mounting portion 5 has limitation on a width rather than the height. It is because a height of the driving unit mounting portion is limited in view of a height of the tub once a total height of the dishwasher is determined taking design, or convenience of use into account.

In general, magnetic flux which is one of factors related to an output of the motor 100 is proportional to a sectional area of the motor (core) 100, if the motor 100 becomes to have the same or larger sectional area by reducing the height ‘H’ of the motor (core) and increasing the diameter ‘D’, the height ‘H’ of the motor 100 can be reduced while the motor has the same power.

In the meantime, if the motor 100 is changed from an inner rotor type to an outer rotor type, the height ‘H’ of the motor 100 can be reduced. That is, since the outer rotor type has a shorter winding length, and a smaller core, the height ‘H’ of the motor 100 can be reduced on the whole. Moreover, in general, the outer rotor type has higher output than the inner rotor type, a number of windings, and a number of cores can be reduced, enabling to reduce the height ‘H’ of the motor 100, further.

In summary, the height ‘H’ of the motor 100 can be reduced without reduction of power of the motor 100 if the concentrated winding is employed, the distributed winding or the concentrated winding is employed while making the diameter of the core greater and the height of the core smaller, or the distributed or concentrated winding is employed in the outer rotor type. Of course, if the outer rotor type is used, the diameter of the core is made greater while the height is made smaller, and the concentrated winding is employed, the height of the motor 100 can be reduced at the greatest extent.

If above scheme is satisfied, though any motor 100 can be used, it is preferable that a DC motor is used instead of the induction motor, and it is more preferable to use a brushless DC motor.

As described, if the height ‘H’ of the motor 100 is reduced, it is possible that the shaft of the motor 100 is mounted parallel to a height direction of the tub 3, i.e., the motor 100 can be mounted upright, which permits more effective use of a side space of the sump 9.

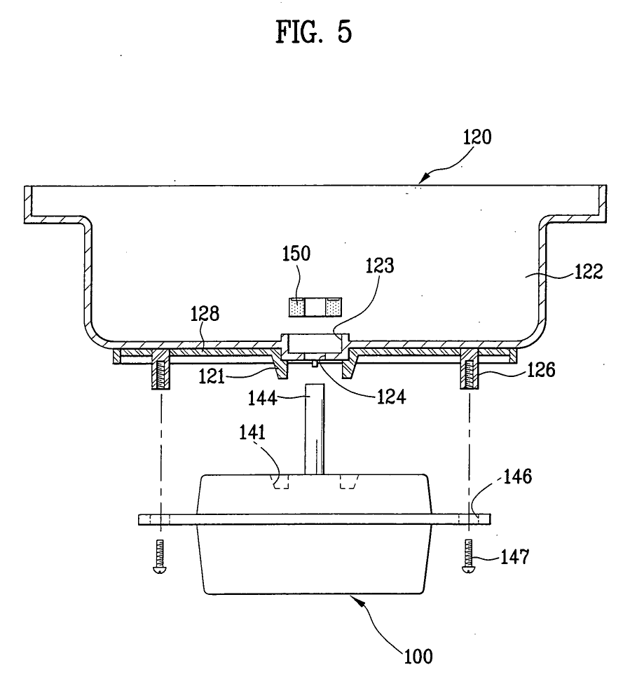

In the meantime, a dishwasher will be described with reference to FIGS. 5 to 7, in which assemble workability is improved by providing a guide piece to the sump and a guide hole in conformity to the guide piece to the motor in a case the upright type motor is mounted.

As shown, a shaft hole 124 is formed in the sump 120 in which the washing water is to be held.

Since the motor 100 is mounted to the underside of the sump 120 for providing power required for circulating the washing water in the sump 100, it is preferable that the shaft hole 124 is formed in an underside surface of a recess 122 at the center of the sump 120.

There are guide pieces 121 projected downward from the underside surface of the sump 120.

Since the motor 100 is secured as the rotation shaft 144 is placed in the shaft hole 124 in the sump 120, it is preferable that the guide pieces 121 are formed around the shaft hole 124.

Moreover, on an upper surface of the motor 100 in contact with the underside surface of the sump 120, there are guide holes 141 at positions opposite to the guide pieces 121 for receiving the guide pieces 121 when the motor 100 is mounted to the sump 120.

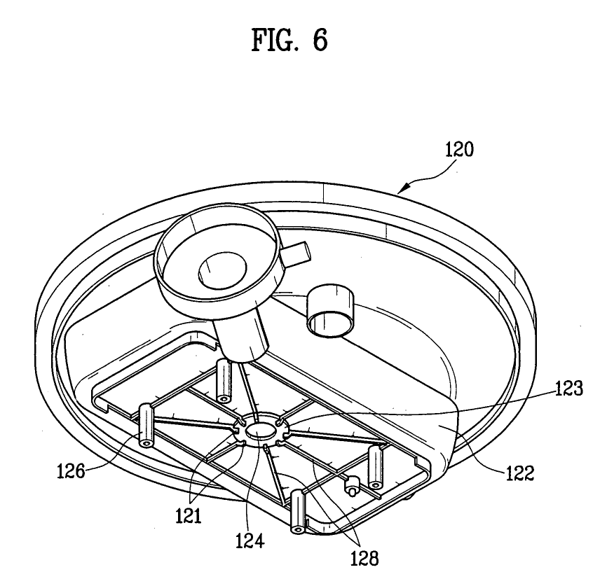

FIG. 6 illustrates a bottom perspective view of a sump having the motor mounting structure of the dishwasher of the present invention applied thereto.

It is preferable that a plurality of the guide pieces 121 are formed around the shaft hole 124 each spaced a predetermined distance away from the shaft hole 124 such that the guide pieces 121 surround the shaft hole 124.

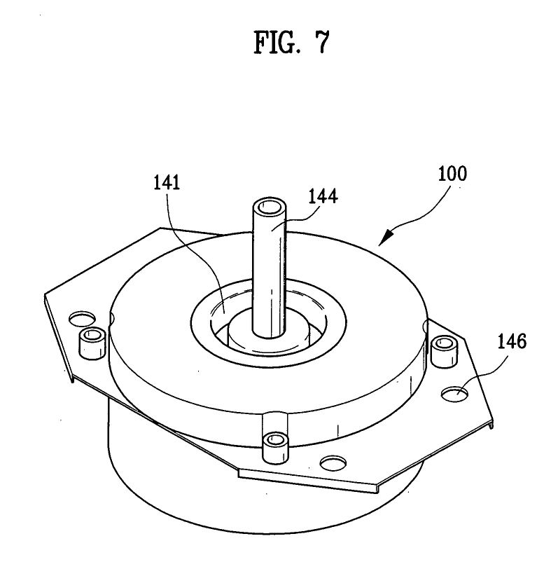

FIG. 7 illustrates a perspective view of the washing motor having the motor mounting structure of the dishwasher of the present invention applied thereto seen from above.

Therefore, when the motor 100 is secured to the underside surface of the sump 120, it is preferable that the guide holes 141 which are to receive the guide pieces 121 are formed spaced a distance away from the rotation shaft 144 which is to be placed in the shaft hole 124 in a fashion surrounding the rotation shaft 144, and it is more preferable that in a shape of a ring.

Moreover, referring to FIG. 5, it is preferable that the guide piece 121 has one sloped side for easy guide of the motor 100.

More preferably, as shown, a sloped surface of the guide piece 121 is sloped such that an end of a side of the guide piece 121 facing an outer side of the sump 120 is directed to a center portion of the sump 120.

There are a plurality of screw fastening bosses 126 projected downward from the underside surface of the recess 122 for screw fastening with the motor 100.

The motor 100 has screw fastening holes 146 at positions opposite to the screw fastening bosses 126.

Therefore, when the motor 100 is mounted to the sump 120, the rotation shaft 144 of the motor 100 passes through the shaft hole 124 in the sump 120, and the guide pieces 121 on the sump 120 are placed in the guide holes 141 in the motor 100 to align a mounting position of the motor 100.

Then, as fastening screws 147 are fastened to the screw fastening holes 146 in the motor 100 and the screw fastening bosses 126 on the sump 120, the motor 100 is fixedly secured.

In this instance, since the sloped surface of the guide piece 121 facing the outer side of the sump 120 is sloped, position alignment of the motor 100 is guided naturally as the guide piece 121 is inserted in the guide hole 141.

Moreover, since the alignment is not disturbed as the motor 100 and the sump 120 are assembled preliminarily by the guide pieces 121 and the guide holes 141, the worker can fasten the fastening screws easily.

Moreover, in a preferred embodiment of the present invention, there is a strength reinforcing rib 128 for improving strength of the sump 120.

In this instance, it is preferable that the strength reinforcing rib 128 is formed at a portion of the sump 120 where the motor 100 is mounted thereto as the portion is liable to deform by weight and rotation force of the motor 100.

In the embodiment, since the motor 100 is mounted to the underside of the recess 122 of the sump 120, it is preferable that the strength reinforcing rib 128 is also formed on the underside of the recess 122.

Moreover, it is preferable that a plurality of the strength reinforcing ribs 128 are formed in a radial direction extended from the shaft hole 124 to an outer side of the sump 120.

It is preferable that the strength reinforcing ribs 128 are extended to edges of the recess 122, where ends of the strength reinforcing ribs 128 are connected to one another.

Moreover, the strength reinforcing ribs 128 may be formed as one body with the guide pieces 121. That is, it is preferable that inner side ends of the strength reinforcing ribs 128 are connected to outer sides of the guide pieces 121.

According to this, since the strength reinforcing ribs 128 are formed on the mounting surface between the sump 120 and the motor 100, deformation of the sump 120 caused by a load or rotation force of the motor 100 is prevented.

Moreover, according to a preferred embodiment of the present invention, it is preferable that a sealing member 150 is provided to the shaft hole 124 of the rotation shaft 144 of the motor 100 for making the recess 122 water tight.

It is preferable that the sealing member 150 has a ring shape for preventing the washing water from leaking from the recess 122 through the shaft hole 124, and secure rotation of the rotation shaft 144 of the motor 100.

The ring shaped sealing member 150 is inserted into the rotation shaft 144 from an upper surface of the shaft hole 124.

Moreover, it is preferable that there is a seating step 123 around the shaft hole 124 where the sealing member 150 is positioned for seating the sealing member 150 thereon.

According to this, the sealing member 150 is seated on the seating step 123 after the sealing member 150 is inserted into the rotation shaft 144.

According to this, assemble workability of the sealing member 150 is improved, and a space of the sump 120 can be secured as much as a height of the downward step of the seating step 123.

### MODE FOR INVENTION

Another embodiment of the present invention for reducing the height of the motor will be described with reference to FIG. 4.

The embodiment enables to reduce the height ‘H’ of the motor 100 even though the related art induction motor is used as it is. That is, by changing a control method of the dishwasher, a required output of the motor 100 itself is reduced to reduce the height ‘H’ of the motor 100.

It will be described in detail. For an example, in the related art dishwasher, the washing water is supplied only to the upper spray arm 32 if the dishes are only on the upper rack 12, and the washing water is supplied only to the lower spray arm 34 if the dishes are only on the lower rack 14. If the dishes are both on the upper rack 12 and the lower rack 14, the washing water is supplied both to the upper spray arm 32 and the lower spray arm 34 at the same time. Therefore, the output of the motor 100 is designed to supply the washing water to the upper spray arm 32 and the lower spray arm 34 at the same time.

However, the according to experiment of the inventor, it is verified that an adequate washing effect can be obtained even if the washing water is supplied to the upper rack 12 and the lower rack 14 alternately at regular intervals, without supplying the washing water to the upper rack 12 and the lower rack 14 at the same time even when the dishes are both on the upper rack 12 and the lower rack 14.

Therefore, the output of the motor 100 can be designed enough to supply the washing water either to the upper spray arm 32 or the lower spray arm 34, enabling to reduce the output of the motor 100 itself, to reduce the height ‘H’ of the motor 100 itself.

In this instance, it is preferable that the output of the motor 100 is adjusted to supply the washing water to the upper spray arm 32, effectively. Moreover, it is preferable that a variable speed motor is used to increase a rotation speed of the motor when the washing water is supplied to the upper spray arm 32.

Another embodiment of the present invention will be described with reference to FIG. 4.

In the embodiment, a mounting position of the heater 13 is changed, for increasing a height of the tub 3. That is, besides the adjustment of the height of the motor 100, by changing the mounting position of the heater 13, an actual space of the tub 3 can be made larger.

If the heater 13 is mounted to the sump 9 for heating the washing water, the actual space of the tub 3 can be made larger. Because a space for mounting the heater 13 between the lower spray arm 34 and a bottom of the tub 3 in the related art can be used as a space of the tub 3.

The operation of the dishwasher of the present invention will be described.

Upon putting the dishwasher into operation, the washing water in the sump 9 is heated by the heater 13, and pumped by the washing pump. The pumped washing water is supplied to the upper spray arm and/or the lower spray arm 34 in the tub 3 selectively by the flow control valve (not shown). In this instance, as described before, it is preferable that the washing water is supplied to the upper spray arm 32 and the lower spray arm 34, not at the same time, but alternately. The washing water sprayed to the dishes is recovered to the sump 9 again through the recovery holes (not shown) in communication with the sump 9. In this instance, the washing water containing soil as the washing water washes the dishes may be filtered through predetermined filtering means.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

### INDUSTRIAL APPLICABILITY

The dishwasher of the present invention having the following excellent advantages has industrial applicability.

First, the reduction of a motor height enabling to reduce a height of a driving unit mounting portion permits to make a higher tub to use the tub more effectively. The mounting of the heater in the driving unit mounting portion, i.e., in the sump permits effective use of the tub space.

Second, the reduction of the motor also permits effective use of a space of the driving unit mounting space.

Third, the alignment of the screw fastening bosses with the screw fasting holes, and the preliminary assembly of the sump and motor at the time of mounting the motor to a bottom of the sump by means of the guide pieces on the sump bottom and the guide holes in the upper surface of the motor permits to improve assemble workability.

Fourth, the strength reinforcing ribs on the bottom of the sump on which the motor is to be mounted prevent the sump from being deformed by a weight and rotation of the motor.

Fifth, the downward sealing seating step around the shaft hole in the sump for seating a sealing member improves assemble work of the sealing member, and permits to secure a more space as much as the downward step.

1. A dishwasher comprising:
a tub for placing dishes to be washed therein;
a sump for holding washing water to wash the dishes in the tub; and
a motor having a rotor and a stator for generating pumping force to pump the washing water from the sump to the tub,
wherein the stator of the motor has a concentrated winding.

2. The dishwasher as claimed in claim 1, wherein the motor has a diameter greater than a height of the motor, to have a required output.

3. The dishwasher as claimed in claim 1, wherein the motor is of an outer rotor type.

4. The dishwasher as claimed in claim 1, wherein the motor is a brushless DC motor.

5. The dishwasher as claimed in claim 1, wherein the sump has a heater mounted therein for heating the washing water in the sump.

6. The dishwasher as claimed in claim 1, wherein the tub has an upper spray arm and a lower spray arm mounted therein wherein the washing water is not supplied to the upper spray arm and the lower spray arm at the same time.

7. A dishwasher comprising:
a tub for placing dishes to be washed therein;
a sump for holding washing water to wash the dishes in the tub; and
a motor having a rotor and a stator for generating pumping force to pump the washing water from the sump to the tub,
wherein the stator of the motor has a diameter greater than a height of the motor, to have a required output.

8. The dishwasher as claimed in claim 7, wherein the sump has a heater mounted therein for heating the washing water in the sump.

9. The dishwasher as claimed in claim 7, wherein the tub has an upper spray arm and a lower spray arm mounted therein wherein the washing water is not supplied to the upper spray arm and the lower spray arm at the same time.

10. A dishwasher comprising:
a tub for placing dishes to be washed therein;
a sump for holding washing water to wash the dishes in the tub; and
a motor having a rotor and a stator for generating pumping force to pump the washing water from the sump to the tub,
wherein the motor is of an outer rotor type for making a length of the winding shorter.

11. The dishwasher as claimed in claim 10, wherein the sump has a heater mounted therein for heating the washing water in the sump.

12. The dishwasher as claimed in claim 10, wherein the tub has an upper spray arm and a lower spray arm mounted therein wherein the washing water is not supplied to the upper spray arm and the lower spray arm at the same time.

13. A dishwasher comprising:
a tub for placing dishes to be washed therein;
a sump for holding washing water to wash the dishes in the tub, the sump having a shaft hole, and a guide piece projected outward; and
a motor for generating pumping force to pump the washing water from the sump to the tub, the motor having a guide hole for receiving the guide piece on the sump.

14. The dishwasher as claimed in claim 13, wherein the guide piece is formed around the shaft hole, and has a pass through hole corresponding to the shaft hole.

15. The dishwasher as claimed in claim 13, wherein the guide piece has at least one sloped side surface, and the guide hole also has at least one sloped side surface in conformity with the sloped side surface of the guide piece.

16. The dishwasher as claimed in claim 14, wherein the sump has a plurality of strength reinforcing ribs around the guide piece extended outwardly from the shaft hole in a radial direction.

17. The dishwasher as claimed in claim 13, further comprising a sealing member around the shaft hole in the sump.

18. The dishwasher as claimed in claim 13, wherein the motor includes a rotor and a stator, wherein the stator has a concentrated winding.

19. The dishwasher as claimed in claim 13, wherein the motor includes a rotor and a stator, wherein the stator has a diameter greater than a height, to provide a required output.

20. The dishwasher as claimed in claim 13, wherein the motor is of an outer rotor type for making a length of the winding shorter.
